(19) United States
(12) Patent Application Publication
(10) Pub. No.: US 2022/0327419 A1
(43) Pub. Date: Oct. 13, 2022

(54) INCREASING INCLUSIVITY IN MACHINE LEARNING OUTPUTS

(71) Applicant: AT&T Intellectual Property I, L.P., Atlanta, GA (US)

(72) Inventors: Cheryl Brooks, Maplewood, NJ (US); Balachander Krishnamurthy, New York, NY (US); Subhabrata Majumdar, Jersey City, NJ (US)

(21) Appl. No.: 17/227,311

(22) Filed: Apr. 10, 2021

(51) Int. Cl. G06N 20/00; G06F 16/901

(52) U.S. Cl. CPC G06N 20/00; G06F 16/9024

(57) ABSTRACT

A method includes constructing an information graph based on a set of training data provided to a machine learning algorithm, identifying an area of the information graph in which to increase an inclusion of the information graph, wherein the inclusion comprises a consideration of a population that is underrepresented in the information graph, collecting, from an auxiliary data source, auxiliary data about the population for use in increasing the inclusion of the information graph, utilizing the auxiliary data to increase the inclusion of the information graph, to generate an updated information graph, using the updated information graph to generate a test output that incorporates information from the auxiliary data, generating, when the test output satisfies an inclusion criterion, a runtime output using the updated information graph, receiving user feedback regarding the runtime output, and determining, in response to the user feedback, whether to further increase inclusion of the runtime output.

The present disclosure relates generally to machine learning, and relates more particularly to devices, non-transitory computer-readable media, and methods for incorporating auxiliary data in order to increase the inclusivity of machine learning outputs.

### BACKGROUND

Machine learning is a subset of artificial intelligence encompassing computer algorithms whose outputs improve with experience. A set of sample or “training” data may be provided to a machine learning algorithm, which may learn patterns in the training data that can be used to build a model that is capable of making predictions or decisions (outputs) based on a set of inputs (e.g., new data). Machine learning models may be used to automate the performance of repeated tasks, to filter emails, to provide navigation for unmanned vehicles, and to perform other tasks or actions.

### SUMMARY

The present disclosure broadly discloses methods, computer-readable media, and systems for increasing inclusivity in machine learning outputs. In one example, a method performed by a processing system including at least one processor includes constructing an information graph based on a set of training data provided to a machine learning algorithm, identifying an area of the information graph in which to increase an inclusion of the information graph, wherein the inclusion comprises a consideration of a population that is underrepresented in the information graph, collecting, from one or more auxiliary data sources, auxiliary data about the population that is underrepresented for use in increasing the inclusion of the information graph, utilizing the auxiliary data to increase the inclusion of the information graph, to generate an updated information graph, using the updated information graph to generate test output that incorporates information from the auxiliary data, generating, in response to determining that the test output satisfies an inclusion criterion, a runtime output using the updated information graph, receiving user feedback regarding the runtime output, and determining, in response to the user feedback, whether to repeat the collecting, the utilizing, the using, and the generating to increase an inclusion of the runtime output.

In another example, a non-transitory computer-readable medium may store instructions which, when executed by a processing system including at least one processor, cause the processing system to perform operations. The operations may include constructing an information graph based on a set of training data provided to a machine learning algorithm, identifying an area of the information graph in which to increase an inclusion of the information graph, wherein the inclusion comprises a consideration of a population that is underrepresented in the information graph, collecting, from one or more auxiliary data source(s), auxiliary data about the population that is underrepresented for use in increasing the inclusion of the information graph, utilizing the auxiliary data to increase the inclusion of the information graph, to generate an updated information graph, using the updated information graph to generate test output that incorporates information from the auxiliary data, generating, in response to determining that the test output satisfies an inclusion criterion, a runtime output using the updated information graph, receiving user feedback regarding the runtime output, and determining, in response to the user feedback, whether to repeat the collecting, the utilizing, the using, and the generating to increase an inclusion of the runtime output.

In another example, a device may include a processing system including at least one processor and a non-transitory computer-readable medium storing instructions which, when executed by the processing system, cause the processing system to perform operations. The operations may include constructing an information graph based on a set of training data provided to a machine learning algorithm, identifying an area of the information graph in which to increase an inclusion of the information graph, wherein the inclusion comprises a consideration of a population that is underrepresented in the information graph, collecting, from one or more auxiliary data source(s), auxiliary data about the population that is underrepresented for use in increasing the inclusion of the information graph, utilizing the auxiliary data to increase the inclusion of the information graph, to generate an updated information graph, using the updated information graph to generate test output that incorporates information from the auxiliary data, generating, in response to determining that the test output satisfies an inclusion criterion, a runtime output using the updated information graph, receiving user feedback regarding the runtime output, and determining, in response to the user feedback, whether to repeat the collecting, the utilizing, the using, and the generating to increase an inclusion of the runtime output.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for increasing inclusivity in machine learning outputs may operate;

FIG. 2 illustrates a flowchart of an example method for augmenting a machine learning technique to increase inclusion, in accordance with the present disclosure;

FIG. 3 illustrates an example information graph that may be constructed based on a set of training data; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for increasing inclusivity in machine learning outputs. As discussed above, machine learning algorithms are trained using a set of training data to make predictions or decisions (outputs) based on a set of inputs (e.g., new data). However, depending on the source of the training data, there may be inherent biases present in the training data that result in weaknesses in the machine learning output. The weaknesses or biases in the training data may or may not relate to sensitive and/or legally protected demographic populations and underrepresented minority populations.

To envision this problem, one might consider an example information graph (versions of information graphs may also be referred to as “knowledge graphs” in machine learning literature) that represents associations between a set of entities, where the set of entities comprises a sample from a larger population of entities, and the associations between the entities may be learned from analysis of data. Since the information graph is inferred from a finite set of sample data, parts of the information graph may be considered weak due to data deficiencies (e.g., insufficient samples, lack of relevant features, missing data, and the like).

Conventional methods for mitigating such data deficiencies tend to be reactive. That is, these methods focus on ad hoc solutions for addressing identified weaknesses that are already present in the information graph. The goal of these methods is typically to reduce bias in the information graph against known sensitive categories (such as race, gender, or the like), but not necessarily to increase the inclusion. By contrast, the present disclosure presents a proactive approach to identify weaknesses that may or may not pertain to known issues such as bias, lack of fairness, and privacy. More specifically, while bias mitigation efforts may target mitigation of known problems, the inclusion efforts disclosed herein detect and mitigate problems which may or may not be related to bias and/or fairness.

To increase the inclusion of the information graph, the parts of the information graph that could benefit from an expansion in some dimension (to mitigate a weakness or to broaden the scope) may first be identified (e.g., either proactively or reactively). A weak part of the information graph might comprise, for example, an area of the information graph where there appears to be a sparse number of entities with respect to a category of interest (e.g., race, gender, country of origin, etc.), or an area where the information graph appears to lack a sharp distinction between associations and disassociations between entities. Thus, the information graph might benefit from expansion with respect to the entities, with respect to the features or data from which the associations between the entities are learned, or with respect to both the entities and the features or data.

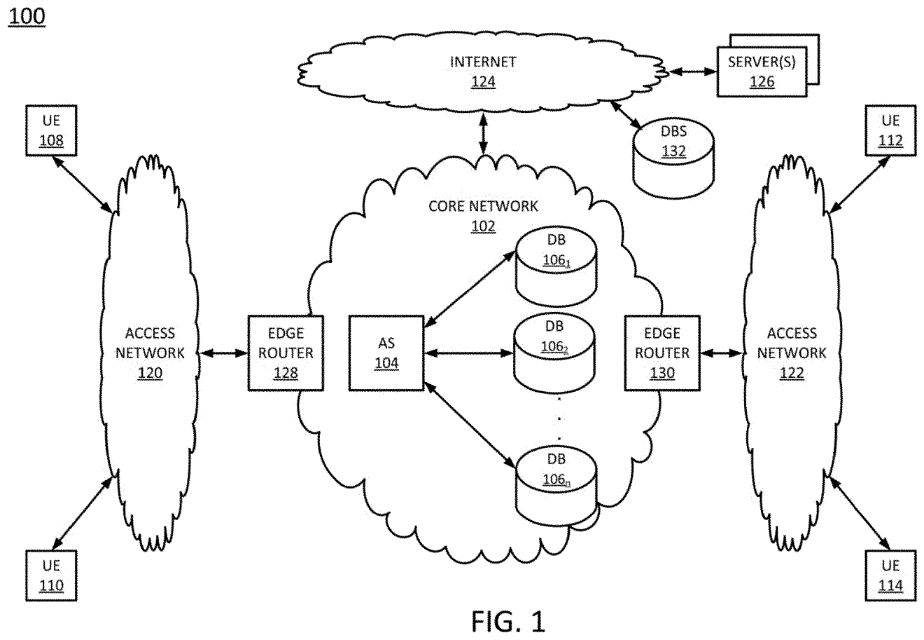

Examples of the present disclosure identify weaknesses in the training data provided to a machine learning algorithm and then augment that training data with data from an auxiliary data source in order to increase the inclusion of a machine learning model's output. The increased inclusion in fact addresses two different problems with respect to conventional machine learning techniques: (1) exclusion (which may be a result of a lack of diversity in the training data); and (2) lack of contextual knowledge. Both of these problems are inextricably linked to bias in machine learning outputs. These and other aspects of the present disclosure are discussed in greater detail below in connection with the examples of FIGS. 1-4.

To further aid in understanding the present disclosure, FIG. 1 illustrates an example system 100 in which examples of the present disclosure for increasing inclusivity in machine learning outputs may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, a plurality of databases (DBs) 106₁-106ₙ (hereinafter individually referred to as a “database 106” or collectively referred to as “databases 106”), and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

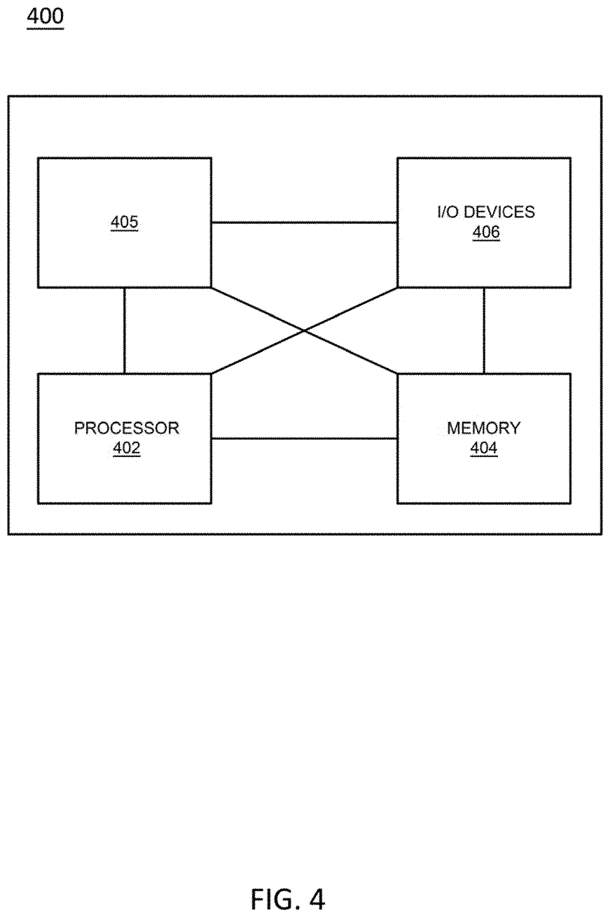

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 400 depicted in FIG. 4, and may be configured as described below. For example, the user endpoint devices 108, 110, 112, and 114 may each comprise a mobile device, a cellular smart phone, a gaming console, a set top box, a laptop computer, a tablet computer, a desktop computer, an application server, a bank or cluster of such devices, and the like. In one example, any one of the user endpoint devices 108, 110, 112, and 114 may be operable by a human user to provide guidance and feedback to the AS 104, which may be configured to train a machine learning model in a manner that increases the inclusivity of the machine learning model, as discussed in greater detail below.

In one example, one or more servers 126 and one or more databases 132 may be accessible to user endpoint devices 108, 110, 112, and 114 via Internet 124 in general. The server(s) 126 and DBs 132 may be associated with Internet content providers, e.g., entities that provide content (e.g., news, blogs, videos, music, files, products, services, or the like) in the form of websites (e.g., social media sites, general reference sites, online encyclopedias, or the like) to users over the Internet 124. Thus, some of the servers 126 and DBs 132 may comprise content servers, e.g., servers that store content such as images, text, video, and the like which may be served to web browser applications executing on the user endpoint devices 108, 110, 112, and 114 and/or to AS 104 in the form of websites.

In accordance with the present disclosure, the AS 104 may be configured to provide one or more operations or functions in connection with examples of the present disclosure for increasing inclusivity in machine learning outputs, as described herein. The AS 104 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, the AS 104 may be configured to train machine learning models by providing training data to one or more machine learning algorithms. In particular, the AS 104 may be configured to identify weaknesses or areas in the training data where inclusion (i.e., consideration of underrepresented populations) can be improved. For instance, in one example, the AS 104 may be programmed to construct an information graph based on the training data, where the information graph comprises a data structure that organizes the training data into entities and relationships between those entities. By examining the information graph, the AS 104 may be able to identify areas of the information graph where data is sparse or where inclusion could be improved (even if the data is not necessarily sparse).

The AS 104 may also be configured to identify auxiliary data sources which may function as sources of auxiliary data that can be incorporated into the training data to improve inclusion. For instance, each of the DBs 106 and 132 may operate as an auxiliary data source that contains information about a specific underrepresented population (or other population that has otherwise been targeted for greater inclusion). As an example, DB 106₁ may store data about African American superheroes, DB 1062 may store data about Southeast Asian film directors, DB 106ₙ may store data about female molecular biologists, and so on. New auxiliary data sources may be added at any time to the set of DBs 106 to address new and evolving inclusion needs. Moreover, existing DBs may be updated at any time to include new data about underrepresented populations (e.g., results from machine learning models which have been augmented to increase inclusion).

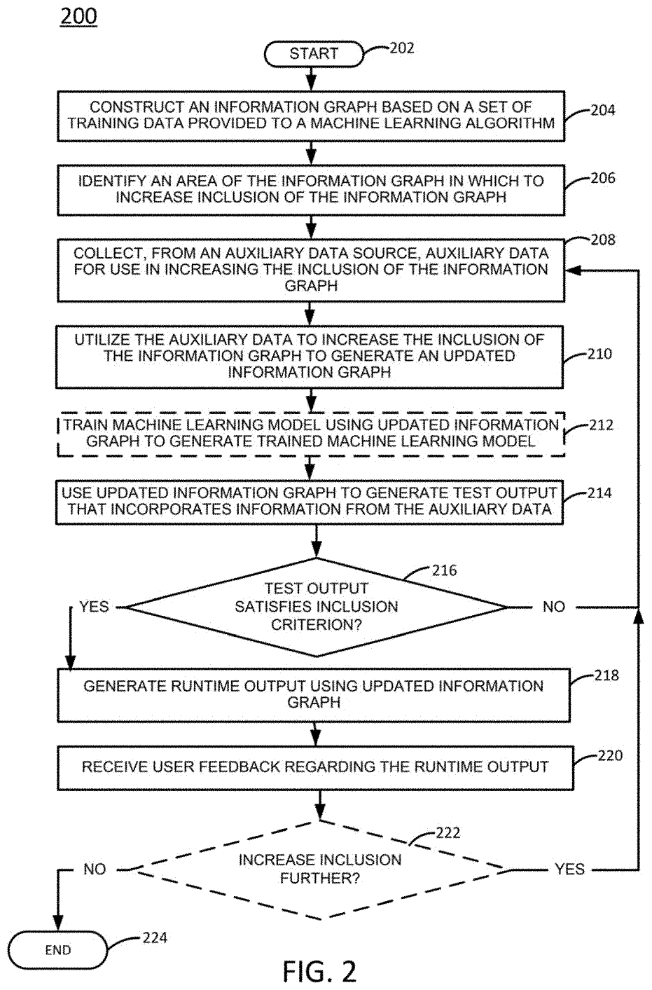

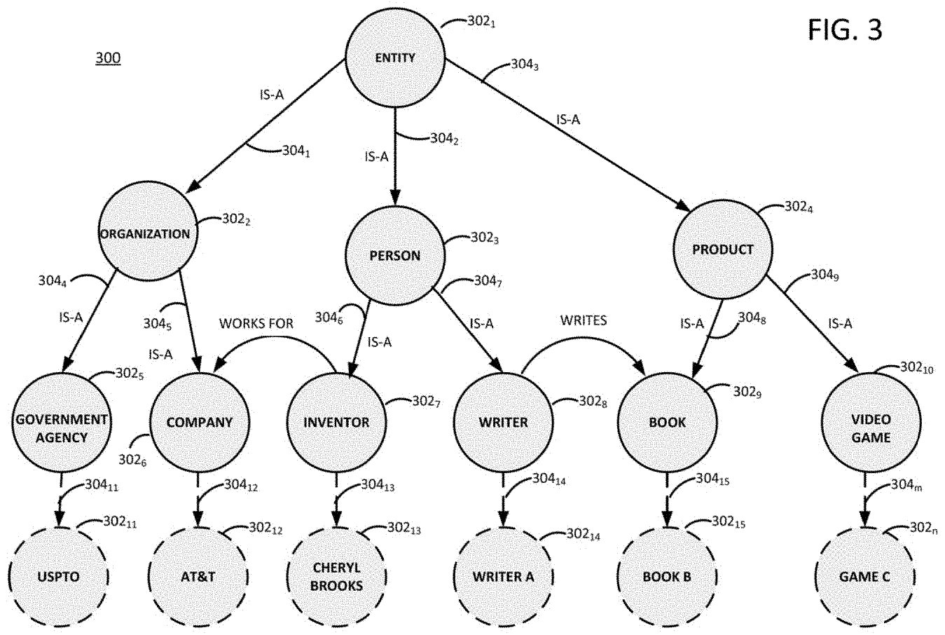

In one example, the DBs 106 may comprise physical storage devices integrated with the AS 104 (e.g., a database server or a file server), or attached or coupled to the AS 104, in accordance with the present disclosure. In one example, the AS 104 may load instructions into a memory, or one or more distributed memory units, and execute the instructions for increasing inclusivity in machine learning outputs, as described herein. Example methods for increasing inclusivity in machine learning outputs are described in greater detail below in connection with FIGS. 2-3.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

FIG. 2 illustrates a flowchart of an example method 200 for augmenting a machine learning technique to increase inclusion, in accordance with the present disclosure. In one example, steps, functions and/or operations of the method 200 may be performed by a device as illustrated in FIG. 1, e.g., AS 104 or any one or more components thereof. In another example, the steps, functions, or operations of method 200 may be performed by a computing device or system 400, and/or a processing system 402 as described in connection with FIG. 4 below. For instance, the computing device 400 may represent at least a portion of the AS 104 in accordance with the present disclosure. For illustrative purposes, the method 200 is described in greater detail below in connection with an example performed by a processing system in an Internet service provider network, such as processing system 402.

The method 200 begins in step 202 and proceeds to step 204. In step 204, the processing system may construct an information graph based on a set of training data provided to a machine learning algorithm. As discussed above, the set of training data may comprise a sample taken from a larger population of data and provided to the machine learning algorithm for the purposes of training a machine learning model to make predictions or decisions.

FIG. 3, for instance, illustrates an example information graph 300 that may be constructed based on a set of training data. In one example, the information graph 300 may comprise a plurality of nodes 302₁-302ₙ (hereinafter individually referred to as a “node 302” or collectively referred to as “nodes 302”) and a plurality of edges 304₁-304ₘ (hereinafter individually referred to as an “edge 304” or collectively referred to as “edges 304”) connecting the plurality of nodes 302. Each node 302 may represent an entity (e.g., an organization, a person, a product, or the like) indicated in the set of training data, while each edge 304 may represent a relationship between the entities whose nodes 302 are connected by the edge 304. In one example, each edge 304 may be labeled to describe the nature of the relationship between the entities (e.g., “is-a,” “works for,” “writes,” etc.). Each edge 304 may also be directed to show the direction in which the relationship exists (e.g., the edge 304₁ from node 302₁ to node 3022 is labeled and directed to indicate that an “organization” is a type of “entity”, as opposed to, for instance, an “entity” being a type of “organization”). Nodes 302 and edges 304 which are illustrated in dashed lines represent specific instances of the types of the nodes 302 to which they are connected (e.g., the “USPTO” is a specific instance of a “government agency”). Referring back to FIG. 2, in step 206, the processing system may identify an area of the information graph in which to increase inclusion of the information graph, wherein the inclusion comprises a consideration of a population that is underrepresented in the information graph. In one example, the area of the information graph in which to increase inclusion may be identified based on a signal from a human user who has reviewed the information graph. In one example, the area of the information graph in which inclusion is to be increased may be identified based on contextual information about the machine learning model or information graph (e.g., use case, sensitive features, sample segments, etc.).

For instance, the human user may have reviewed the information graph and determined that a particular area of the information graph is sparse relative to other areas of the information graph. For instance, referring to the example information graph 300, the human user may determine that the area of the information graph relating to “Inventor” (i.e., node 3027) is sparse and could benefit from expansion.

In another example, the human user may have determined that a particular entity is underrepresented in the information graph. The underrepresented entity may comprise, for example, a group of people who share some characteristic that may be historically or culturally underrepresented. The characteristic may relate, for instance, to gender, race, nationality, religion, age, occupation, education (e.g., level of education such as degree or area of educational background such as engineering, liberal arts, languages, etc.), interests, or other characteristics. For instance, where a machine learning model is to be trained to identify candidates for a job opening, the human user may determine that the information graph could be expanded to include more information representing racial minority candidates, or candidates who come from a particular educational background. For instance, an information graph that is constructed to identify candidates for a data scientist position, where some nodes may represent a specific candidate, may be expanded to include information (e.g., new nodes, weightings applied to new or existing nodes, or features related to new or existing nodes) representing racial minority data scientists or to include information representing physicists (since many data scientists may start out working as physicists).

In another example, the underrepresentation may be less general and more contextual, e.g., rooted in the context of the information graph and the purpose of the machine learning model. For instance, where a machine learning model is to be trained to identify pedestrians for the purposes of helping self-driving cars avoid collisions, the human user may determine that the information graph could be expanded to include more information representing pedestrians who are jaywalking (e.g., crossing against traffic signals or outside of crosswalks) or otherwise appearing in unexpected places.

In another example, the processing system may identify an area of the information graph in which to increase inclusion automatically (i.e., without human assistance). In one example, automatic identification of areas for increased inclusion may be identified based on data sparsity. For instance, the processing system may identify an area of the graph where the data density falls below some predefined threshold (such as a mean or median or other threshold) data density for the information graph.

In step 208, the processing system may collect, from an auxiliary data source, auxiliary data about the population that is underrepresented for use in increasing the inclusion of the information graph. In one example, a plurality of auxiliary data sources may be available to the processing system, where each auxiliary data source of the plurality of auxiliary data sources comprises a database that contains data about a specific underrepresented population. For instance, different auxiliary data sources may be created for African American superheroes, Southeast Asian film directors, female molecular biologists, and the like. If an auxiliary data source does not already exist to satisfy a particular area for inclusion, a new auxiliary data source can be created, potentially under the direction of a human user who may review data from multiple sources for inclusion in the new auxiliary data source. Thus, collection of auxiliary data in step 208 may target one or more specific auxiliary data sources.

In step 210, the processing system may utilize the auxiliary data to increase the inclusion of the information graph to generate an updated information graph. In one example, based on the auxiliary data, the processing system may create one or more new nodes of the information graph, where the new nodes represent new entities. In another example, based on the auxiliary data, the processing system may add new information to a new or existing node of the information graph (e.g., new attributes, new weights, etc.). In yet another example, based on the auxiliary data, the processing system may update the information graph with new learned relationships between data already contained in the information graph and newly discovered data (which may include the auxiliary data or data discovered through the auxiliary data). In yet another example, the processing system may update the information graph to include a further category of data discovered through the auxiliary data. For instance, a search of a database containing information about racial minority movie directors may lead to the discovery of information about opening weekend box office returns for these directors. In this case, the information graph could be updated with information about both the racial minority directors and the opening weekend box office returns for these directors.

To extract maximum information from the auxiliary data relevant to the current machine learning model, in one example data from the auxiliary data source(s) may be modified while integrating the data from the auxiliary data source(s) into the updated information graph. This may be done using techniques such as providing different weights for, or using subsets of samples from, the original and auxiliary datasets.

As an example, the example information graph 300 illustrated in FIG. 3 may be expanded to include additional nodes for additional types of people (i.e., node 3023), where the additional types of people may include underrepresented populations or groups. In another example, the processing system may update the relationships between the nodes of the information graph. For instance, the inclusion of new nodes might necessitate the inclusion of new edges to indicate any relationships between the new nodes and other new nodes, or between the new nodes and the nodes that existed prior to step 210. Additionally, the auxiliary data may shed light on the existence of previously unknown relationships between some of the nodes that existed prior to step 210.

In another example, the auxiliary data may be integrated into the information graph in other ways. For instance, rather than being used to create a new node, auxiliary data could be used to generate or update a weighting of a given node or edge or to perform sampling.

In optional step 212 (illustrated in phantom), the processing system may train the machine learning model using the updated information graph. That is, the updated information graph may be provided as an input to a machine learning algorithm, which may train the machine learning model to produce a particular prediction or decision. In one example, the selection of the machine learning algorithm may be based at least in part on the purpose (e.g., use case(s)) of the machine learning model. For instance, the machine learning algorithm may comprise a deep learning algorithm, a neural network, or another type of machine learning algorithm.

In step 214, the processing system may use the updated information graph to generate a test output that incorporates the information from the auxiliary data. In one example, where step 212 is performed, the test output may be generated using the machine learning model. For instance, new data may be provided as input to the machine learning model, and the test output may comprise the output generated by the machine learning model based on the new data. However, in another example, the test output may be generated in another manner. For instance, the processing system may generate the test output by traversing the updated information graph to discover new data features, new relationships, and the like.

In step 216, the processing system may determine whether the test output satisfies a criterion for inclusion. In one example, the inclusion criterion may be predefined, such that the processing system can autonomously evaluate the inclusion of the test output against the criterion. In another example, however, the inclusion criterion may not be predefined. Having an inclusion criterion that is not predefined may more easily allow for the discovery of new useful features and data, since there is no defined stopping point. This, in turn, may allow for more effective discovery of previously unknown or ignored inclusion criteria, which may lead to further expansion of the information graph. For instance, an initial inclusion criterion seeks to identify more female data scientists. A search of an auxiliary database containing information about data scientists belonging to underrepresented groups may lead to the discovery not just of more female data scientists, but also to data scientists who belong to other underrepresented groups. Based on this discovery, the party performing the search may wish to further expand the scope of the search.

In one example, the determination as to whether the test output satisfies the criterion for inclusion may be made based on a signal from a human user. For instance, the user may provide a signal to the processing system indicating that the process utilized to generate the test output (e.g., execution of the machine learning model or another process such as traversal of the updated information graph) should be deployed in a runtime environment. Alternatively, the human user may provide a signal indicating that further expansion of the information graph should be performed (e.g., to further increase inclusion). The further expansion may include further expansion in an area that has already been expanded (e.g., potentially by utilizing data from new auxiliary data sources), or may include expansion of a new area that has not yet been expanded.

If the processing system determines in step 216 that the test output does not satisfy the criterion for inclusion, then the method 200 may return to step 208, and the processing system may collect additional auxiliary data (e.g., from the same auxiliary data source(s) and/or from another auxiliary data source). The method 200 may then proceed as described above in connection with steps 210-214.

If, however, the processing system determines in step 216 that the test output does satisfy the criterion for inclusion, then the method 200 may proceed to step 218. In step 218, the processing system may generate a runtime output using the updated information graph. That is, the updated information graph may be deployed for use in generating a prediction or decision based on a new input which is not a test or training input.

In step 220, the processing system may receive feedback from a user regarding the runtime output. For instance, a human user may review the runtime output and may indicate whether the runtime output was satisfactory or unsatisfactory (e.g., whether the runtime output was sufficiently inclusive for the desired context), or whether the human user has any suggestions for improvement of the runtime output (e.g., the auxiliary data source from which auxiliary data was collected in step 208 was too small, so additional auxiliary data or a new auxiliary data source should be utilized to further increase the inclusion of the information graph). For instance, if the auxiliary data source from which auxiliary data was collected in step 208 contained information about female and racial minority data scientists, the feedback may comprise a suggestion to further increase the inclusion of the information graph by utilizing data from a new auxiliary data source that contains information about data scientists who earned degrees from a specific set of (previously underrepresented) colleges and universities (e.g., historically black colleges and universities).

In optional step 222 (illustrated in phantom), the processing system may determine whether the inclusion of the information graph and/or the runtime output should be further increased, based on the feedback received in step 220. If the processing system determines in step 222 that the inclusion of the information graph and/or the runtime output should not be increased further, then the method 200 may end in step 224. Alternatively, if the processing system determines in step 222 that the inclusion of the information graph and/or the runtime output should be increased further, then the method 200 may return to step 208, and the processing system may continue as described above to collect additional auxiliary data from the same and/or a new auxiliary data source. Steps 210-220 may also be repeated as described above to expand the information graph (and optionally to retrain the machine learning model) based on the additional auxiliary data until the inclusion of the information graph is determined to be sufficient for a desired use context.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

Thus, in some examples, the method 200 may identify weaknesses in the training data provided to a machine learning algorithm and then augment that training data with data from an auxiliary data source in order to increase the inclusion of a machine learning model's output. In other examples, the auxiliary data may be used to augment an information graph that may be used by other processes. In further examples, the auxiliary data may be used to augment the output of a machine learning model instead of or in addition to the data used to train the machine learning model. The auxiliary data may contain data that was previously unknown to or ignored by the machine learning model. For instance, the auxiliary data may include attributes or features which were not present in the training data which may allow for new and deeper insights into the space being explored. In further examples still, the auxiliary data may be utilized to augment the inclusion of a machine learning model at a specific checkpoint in the training of the machine learning model. The ability to increase the inclusion of the information graph and/or the machine learning output may be useful in a variety of applications where knowledge of underrepresented populations may be beneficial.

For instance, examples of the present disclosure could be used to determine promising subjects in the world of filmmaking. Typically, when a film studio has produced a new film, the studio will prepare a trailer for the new film and determine the likely audience for the new film. The identification of the likely audience is useful both for coordinating targeted advertising (e.g., selecting advertising that is expected to be of interest to the likely audience) and for growing the audience (e.g., if the film is similar to other successful films), and the likely audience may be determined using machine learning techniques. For instance, if the new film is an action movie, then the likely audience for the new film may be assumed (prior to performing any machine learning) to include fans of films starring a famous action movie actor. In addition, machine learning techniques could be used to determine that the new film is also similar to superhero movies, thereby expanding the scope of the likely audience to include fans of superhero movies.

Although this approach may succeed in growing the audience for the new film, the analysis may also fail to consider large segments of potential audience who could grow the total audience even more. In other words, the audience could be grown further, if only there were a way to identify other related media (and their audiences) which wouldn't be identified under the existing predictions (also referred to as “false negatives”). As an example, in 2018, one of the world's biggest motion picture studios released its first film that was centered on a superhero of African origin, and the film went on to be the second-highest grossing film of that year, worldwide. The lack of films centered on more ethnically and racially diverse superheroes prior to 2018 was not necessarily due to bias, but more likely due to a lack of awareness among the major film studios that such films had the potential to be so commercially successful.

Moreover, one of the writers of that film is African American. If this writer's name were to be included in a database of screenwriters of minority descent, this database might allow one to see that this writer also wrote for several television shows of a genre that is different than the film's genre (e.g., true crime as opposed to action/superheroes). Fans of the true crime genre might not be assumed to be part of the likely audience for a superhero movie. However, because the fans of these particular true crime television shows may enjoy the writing of this particular writer, the fans might be compelled to see other television shows and films on which this writer worked. Thus, the writer could bring to the film an entirely new population of potential viewers who would not have been predicted as being the likely audience for the film using conventional machine learning models. Merely adding this writer's name as a node in an information graph, however, may not have been enough to ensure that the writer was considered as a potential writer for the superhero film (e.g., a single writer's name may have very little influence on the predictions generated using an information graph due to the large number of other names also included in the information graph). But by utilizing information in the database of screenwriters of minority descent to augment a shortlist of potential writers (e.g., as might have been output by a machine learning algorithm), greater consideration may be given to the writer who may not have otherwise be considered (and the potential audience he may bring).

Thus, in the case where the audience for a new film is being determined, a conventional approach might construct an information graph in which the nodes represent existing films, and the relationships represented by the edges are based on learned patterns in audience preferences. In this case, the new film may be added to the information graph, and the likely audience may be predicted based on past audiences for the existing films for which the relationships to the new film are strongest. There are two key weaknesses to this approach. For one, the approach may ignore slightly weaker relationships among films. For another, the relationships are based on what audiences have seen in the past, which may introduce false negatives into the analysis (e.g., an audience member who has only seen films starring a famous action hero might also enjoy a comedy film).

According to examples of the present disclosure, a weakness may be identified in the information graph, namely, that the set of films for which the relationship with the new film is strongest does not include many filmmakers from an underrepresented group (where the group may be determined based on race, gender, ethnicity, or other characteristics). This underrepresented group may thus comprise an expansion area for the information graph, or an area where inclusion can be improved. Auxiliary data may be incorporated into the information graph, where the auxiliary data may comprise data about films made by filmmakers from the underrepresented group. For instance, a node may be added for each of the films in the auxiliary data, thereby expanding the set of entities in the information graph and helping to improve the learned associations between the new film and other films. Thus, strong relationships or associations between the new film and other films which might have previously been overlooked can now be identified. This results in a larger likely audience for the new film.

Further examples of the present disclosure could be used to improve knowledge panels that are displayed alongside search engine search results, Internet videos, and the like. Knowledge panels are information windows that appear on certain websites when a user searches for entities (e.g., people, places, organizations, things).

The knowledge panels present a summary or snapshot of information about the entity based on an understanding of available content on the Internet. Typically, the knowledge panels are generated algorithmically and pull information from third party sources that are available via the Internet (such as general reference sites, online encyclopedias, and the like).

Unfortunately, such algorithms may be prone to inferring false associations and/or overlooking relevant information. As an example, when the Notre-Dame cathedral in Paris, France caught fire in April 2019, live streaming videos of the burning cathedral were displayed alongside knowledge panels containing hyperlinks to videos about the Sep. 11, 2001 terrorist attacks in the United States. In this case, the algorithms responsible for creating the knowledge panels inferred an association between images of the burning cathedral and images of other well-known buildings (including the World Trade Center) on fire, but failed to detect the sharp dissimilarity between the events. Display of information related to the September 11 attacks in the knowledge panels alongside the streaming video of the Notre-Dame fire created a false association that potentially misled viewers into believing that the Notre-Dame fire was the result of a terrorist attack (when, in fact, the fire had no known connections to terrorist activity).

As another example, a June 2019 search on a well-known search engine web site for “CRISPR” (i.e., clusters of regularly interspaced short palindromic repeats) generated a knowledge panel that included images of a plurality of male scientists, but failed to include images of any of the well-known female scientists in the field. In other words, the algorithm responsible for generating the knowledge panel failed to recognize an association between the search keyword and images of relevant female scientists.

According to examples of the present disclosure, the results displayed in knowledge panels can be improved by expanding the scope of the information sources considered by the algorithms to fill in the gaps in the knowledge base. In one example, the scope of the information sources may be expanded to specifically include consideration of entities that belong to underrepresented or sensitive categories. For instance, the main missing component in the case of the Notre-Dame knowledge panels was context. Context could have been better inferred by the algorithms by expanding the underlying information graph to include auxiliary data from real-time news coverage, information from microblogging websites and social media, and other information sources, and by utilizing deep learning techniques to expand the feature set to assess similarity between entities represented in the information graph. More specifically, the information graph could have been expanded to include entities related to the sensitive category of terrorism, and the associations between those entities and other entities in the information graph could have been assessed. In the CRISPR case, the information graph could have been expanded to include entities related to the underrepresented category of women practicing in STEM (science, technology, engineering, and mathematics) fields.

Further examples of the present disclosure could be used to improve the manner in which popular international media (e.g., books, television shows, movies, and the like) are introduced to or adapted for American audiences. For instance, novels originally written in languages including Swedish and Italian have been translated into English for American audiences and have gone on to be best sellers in the United States, and several popular American television shows have been based on successful international television shows in markets such as Israel, Japan, and the United Kingdom. In addition, many instances of popular international media have been brought into the American market without adaptation.

Examples of the present disclosure could be used to help identify international media that could be successful in the American market at scale. For example, an information graph could be constructed to include a set of television shows that are popular in the United States as the entities or nodes. The information graph can then be expanded to include nodes for media from international markets. Deep learning algorithms using neural networks could be used to learn associations between the entities from the international market and to identify similarities and dissimilarities between the media that go beyond simple audience metrics. Audience demographic information could be used to identify portions of the information graph where expansion could be targeted.

Further examples of the present disclosure could be used to improve the algorithms used to operate self-driving vehicles. In March 2018, for instance, a pedestrian in Tempe, Ariz. was killed by a self-driving car after the car failed to recognize the pedestrian as a jaywalking pedestrian pushing a bicycle across the street. The National Transportation and Safety Board (NTSB) investigation into the accident revealed several faults, some of which contributed to the pedestrian's death. For example, the algorithms controlling the self-driving car were not able to determine whether the pedestrian was a vehicle, a pedestrian, or some other objects. The algorithms were further unable to predict the pedestrian's trajectory, since each time the pedestrian was re-classified (e.g., as a vehicle, a pedestrian, or another object), the past trajectory information was erased. In addition, it was determined that the algorithms did not consider the possibility that a detected object might be a jaywalking pedestrian.

Examples of the present disclosure could be used to help reduce the number of accidents caused by self-driving vehicles. For instance, in one example, clips of video footage captured by self-driving vehicles could populate the nodes of an information graph (where the clips are assumed to include clips of jaywalking pedestrians, for example). However, the part of the information graph that includes nodes representing “jaywalking pedestrians” may be determined to be weak (e.g., due to data sparsity and/or lack of features that can adequately distinguish jaywalking pedestrians from other types of objects). Thus, the part of the information graph that includes nodes for “jaywalking pedestrians” could be expanded to integrate data from auxiliary data sources, such as images from common types of car accidents.

In further examples, the output of a machine learning model that has been trained according to the method 200 could be used to further augment one or more auxiliary data sources. For instance, an auxiliary data source containing information about data scientists may be updated to include information about a physicist who was recently hired (and identified through a machine learning model trained as described above) to fill a job opening for a data scientist position. Thus, the auxiliary data sources may be continuously updated with new data, which in turn will improve the outputs of any machine learning models which incorporate data from those auxiliary data sources.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for increasing inclusivity in machine learning outputs, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 405 for increasing inclusivity in machine learning outputs (e.g., a software program comprising computer-executable instructions) can be loaded into memory 404 and executed by hardware processor element 402 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for increasing inclusivity in machine learning outputs (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
constructing, by a processing system including at least one processor, an information graph based on a set of training data provided to a machine learning algorithm;
identifying, by the processing system, an area of the information graph in which to increase an inclusion of the information graph, wherein the inclusion comprises a consideration of a population that is underrepresented in the information graph;
collecting, by the processing system from an auxiliary data source, auxiliary data about the population that is underrepresented for use in increasing the inclusion of the information graph;
utilizing, by the processing system, the auxiliary data to increase the inclusion of the information graph, to generate an updated information graph;
using, by the processing system, the updated information graph to generate a test output that incorporates information from the auxiliary data;
generating, by the processing system in response to determining that the test output satisfies an inclusion criterion, a runtime output using the updated information graph;
receiving, by the processing system, user feedback regarding the runtime output; and
determining, by the processing system in response to the user feedback, whether to repeat the collecting, the utilizing, the using, and the generating to increase an inclusion of the runtime output.

2. The method of claim 1, wherein the information graph comprises:
a plurality of nodes, each node of the plurality of nodes representing an entity indicated in the set of training data; and
a plurality of edges connecting the plurality of nodes, each edge of the plurality of edges representing a relationship between a pair of entities of the plurality of entities which are represented by a pair of nodes of the plurality of nodes to which the each edge is connected.

3. The method of claim 2, wherein the each edge is labeled to describe a nature of the relationship.

4. The method of claim 3, wherein the each edge is directed to show a direction of the relationship.

5. The method of claim 2, wherein the utilizing comprises at least one selected from a group of: adding a new node to the plurality of nodes, wherein the new node represents a new entity that is present in the auxiliary data, adding a weight to a new node or an existing node of the plurality of nodes based on information in the auxiliary data, updating the information graph to reflect a relationship between two nodes of the plurality of nodes, wherein the relationship is newly discovered through the auxiliary data, adding a feature to the information graph, and adding a new category of data to the information graph.

6. The method of claim 1, wherein the area of the information graph in which to increase inclusion is identified based on a signal from a human user who has reviewed the information graph.

7. The method of claim 1, wherein the area of the information graph in which to increase inclusion is identified based on contextual information about at least one selected from a group of: the machine learning model and the information graph.

8. The method of claim 1, wherein the area of the information graph in which to increase inclusion is sparse relative to other areas of the information graph.

9. The method of claim 1, wherein the population that is underrepresented in the information graph comprises a group of people who share a characteristic that is historically or culturally underrepresented.

10. The method of claim 9, wherein the characteristic relates to at least one selected from a group of: a gender of the group, a race of the group, a nationality of the group, a religion of the group, an age of the group, an occupation of the group, an education of the group, and an interest of the group.

11. The method of claim 1, wherein the auxiliary data source is selected from among a plurality of auxiliary data sources, and wherein each auxiliary data source of the plurality of auxiliary data sources comprises a database that contains data about a specific underrepresented population.

12. The method of claim 1, further comprising:
repeating, by the processing system subsequent to the using but prior to the generating, the collecting, the utilizing, and the using in response to determining that the test output does not satisfy the inclusion criterion, until the inclusion criterion is satisfied by the test output.

13. The method of claim 1, wherein the auxiliary data source is updated based on the runtime output.

14. The method of claim 1, further comprising:
training, by the processing system subsequent to the utilizing but prior to the using, a machine learning model using the updated information graph to generate a trained machine learning model, wherein the test output is an output of the trained machine learning model.

15. The method of claim 14, further comprising:
retraining, by the processing system, the trained machine learning model using additional auxiliary data when the test output fails to satisfy the inclusion criterion.

16. The method of claim 15, wherein the retraining is performed at a checkpoint in a training process of the trained machine learning model.

17. The method of claim 14, wherein the trained machine learning model is one selected from a group of: a deep learning model and a neural network.

18. The method of claim 1, wherein the inclusion of the runtime output is increased utilizing additional auxiliary data.

19. A non-transitory computer-readable medium storing instructions which, when executed by a processing system including at least one processor, cause the processing system to perform operations, the operations comprising:
constructing an information graph based on a set of training data provided to a machine learning algorithm;
identifying an area of the information graph in which to increase an inclusion of the information graph, wherein the inclusion comprises a consideration of a population that is underrepresented in the information graph;
collecting, from an auxiliary data source, auxiliary data about the population that is underrepresented for use in increasing the inclusion of the information graph;
utilizing the auxiliary data to increase the inclusion of the information graph, to generate an updated information graph;
using the updated information graph to generate a test output that incorporates information from the auxiliary data;
generating, in response to determining that the test output satisfies an inclusion criterion, a runtime output using the updated information graph;
receiving user feedback regarding the runtime output; and
determining, in response to the user feedback, whether to repeat the collecting, the utilizing, the using, and the generating to increase an inclusion of the runtime output.

20. A device comprising:
a processing system including at least one processor; and
a non-transitory computer-readable medium storing instructions which, when executed by the processing system, cause the processing system to perform operations, the operations comprising:
constructing an information graph based on a set of training data provided to a machine learning algorithm;
identifying an area of the information graph in which to increase an inclusion of the information graph, wherein the inclusion comprises a consideration of a population that is underrepresented in the information graph;
collecting, from an auxiliary data source, auxiliary data about the population that is underrepresented for use in increasing the inclusion of the information graph;
utilizing the auxiliary data to increase the inclusion of the information graph, to generate an updated information graph;
using the updated information graph to generate a test output that incorporates information from the auxiliary data;
generating, in response to determining that the test output satisfies an inclusion criterion, a runtime output using the updated information graph;
receiving user feedback regarding the runtime output; and
determining, in response to the user feedback, whether to repeat the collecting, the utilizing, the using, and the generating to increase an inclusion of the runtime output.
